(19) United States
(12) Patent Application Publication
(10) Pub. No.: US 2007/0252784 A1
(43) Pub. Date: Nov. 1, 2007

(54) Plasma Display Panel Drive Method And Plasma Display Device

(76) Inventors: Toshiyuki Maeda, Hyogo (JP); Masashi Kawai, Kyoto (JP); Minoru Takeda, Osaka (JP); Yoshimasa Horie, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/661,142

(22) PCT Filed: Apr. 13, 2006
(86) PCT No.: PCT/JP06/07817

§ 371 Date: Feb. 26, 2007

(30) Foreign Application Priority Data
Apr. 13, 2005 (JP) 2005-115301

(51) Int. Cl. G09G 3/28

(52) U.S. Cl. 345/60

(57) ABSTRACT

One field period is structured of a plurality of subfields (SF), each including an initializing period, writing period, and sustaining period. Performed in the initializing period of each SF is all-cell initializing operation for generating initializing discharge in all the discharge cells to be used for image display, or selective initializing operation for generating initializing discharge in the discharge cells having generated sustaining discharge in the preceding SF. The period allocated to the writing discharge in a SF for the all-cell initializing operation is set shorter than the period allocated to the writing discharge in a SF for the selective initializing operation. This structure provides a plasma display panel driving method and a plasma display device capable of inhibiting increases in black picture level and displaying images at excellent quality.

### TECHNICAL FIELD

The present invention relates to a method of driving a plasma display panel, and a plasma display device using the method.

### BACKGROUND ART

An alternating-current surface-discharging panel representative of plasma display panels (hereinafter abbreviated as “panels”) has a large number of discharge cells formed between a front panel and rear panel thereof faced with each other. In the front panel, a plurality of display electrodes, each made of a pair of scan electrode and sustain electrode, are formed on a front glass substrate in parallel with each other. A dielectric layer and a protective layer are formed to cover. these display electrodes. In the rear panel, a plurality of parallel data electrodes are formed on a rear glass substrate and a dielectric layer is formed over the data electrodes to cover them. Further, a plurality of barrier ribs are formed on the dielectric layer in parallel with the data electrodes. Phosphor layers are formed on the surface of the dielectric layer and the side faces of the barrier ribs. Then, the front panel and the rear panel are faced with each other and sealed together so that the display electrodes and data electrodes intersect with each other. A discharge gas is filled into an inside discharge space formed between the panels. Discharge cells are formed in portions where the respective display electrodes are opposed to the corresponding data electrode's. In a panel structured as above, gas discharge generates ultraviolet light in each discharge cell. This ultraviolet light excites the phosphors of red, green, and blue to emit the respective colors for color display.

A general method of driving a panel is a subfield method: one field period is divided into a plurality of subfields and combination of light-emitting subfields provides gradation display. Among the subfield methods, a novel driving method of minimizing the light emission unrelated to gradation display to inhibit increases in black picture level and improve a contrast ratio is disclosed in Japanese Patent Unexamined Publication No. 2000-242224.

The subfield method is briefly described hereinafter. Each subfield has an initializing period, writing period, and sustaining period. In the initializing period, one of all-cell initializing operation and selective initializing operation is performed. The all-cell initializing operation causes initializing discharge in all the discharge cells used to display an image. The selective discharge operation selectively causes initializing discharge in the discharge cells having generated sustaining discharge in the preceding subfield.

In the all-cell initializing period, initializing discharge operation is caused in all the discharge cells at a time, to erase the history of wall electric charge previously formed in the respective discharge cells and form wall electric charge necessary for the subsequent writing operation. Additionally, this initializing discharge operation serves to generate priming (priming for discharge =excited particles) for reducing discharge delay and causing stable writing discharge. In the selective initializing period, wall charge necessary for writing operation is formed in the discharge cells having generated sustaining discharge in the preceding subfield. In the subsequent writing period, scan pulses are sequentially applied to the scan electrodes, and write pulses corresponding to the signals of an image to be displayed are applied to the data electrodes. Thus, selective writing discharge is caused between the scan electrodes and corresponding data electrodes to selectively form wall charge. In the sustaining period, a predetermined number of sustain pulses according to the brightness weight is applied between the scan electrodes and corresponding sustain electrodes to cause selective discharge for light emission in the discharge cells in which writing discharge has formed wall charge. Then, reducing the number of subfields in which the all-cell initializing occurs can decrease the light emission unrelated to gradations, thus inhibiting increases in black picture level.

To properly display an image, securely performing the selective writing discharge in the writing period is important. However, there are many factors in increasing discharge delay during writing discharge, such as restrictions on circuitry prohibiting the use of high voltage for a write pulse, and phosphor layers formed on the data electrodes hindering occurrence of discharge. For this reason, the priming for causing stable writing discharge is extremely important.

Recently, active considerations have been given to the structures or materials of the panel so that the panel can meet the requirements for reduction in power consumption and increases in brightness. For example, it is generally known that increasing the partial pressure of xenon in the discharge gas filled into the panel improves the luminous efficiency of the panel. However, for the above panel and method of driving the panel, increases in the partial pressure of xenon destabilizes writing discharge. This unstable discharge poses a problem of writing failures in the writing period that are caused by a narrower margin of the driving voltage in the wiring operation.

### SUMMARY OF THE INVENTION

The present invention aims to address these problems, and provides a panel driving method and a plasma display device in which stabilizing writing discharge inhibits increases in black picture level and allows images to be displayed at high quality.

The present invention includes a plurality of subfields (SFs), each including an initializing period for generating initializing discharge in discharge cells, a writing period for generating writing discharge in the discharge cells, and a sustaining period for generating sustaining discharge to cause the discharge cells to emit light at a predetermined brightness weight. The initializing discharge includes all-cell initializing operation for causing initializing operation in all the discharge cells used to display an image, and selective initializing operation for selectively causing initializing operation in the cells having generated sustaining discharge in the preceding subfield. The period allocated to the writing discharge in a SF for performing the all-cell initializing operation is set shorter than the period allocated to the writing discharge in a SF for the selective initializing operation. Each of the discharge cells is formed at an intersection of scan and sustain electrodes and a data electrode. One aspect of the present invention provides a panel driving method, including determining to cause one of the all-cell initializing operation and the selective initializing operation in the initializing period of each of the plurality of SFs. This method can stabilize the writing discharge and provide a panel driving method capable of inhibiting increases in black picture level and displaying images at high quality.

Another aspect of the present invention provides a panel driving method, wherein the period allocated to the writing discharge in a SF preceding a SF for performing the all-cell initializing operation is set longer than the period allocated to the writing discharge in a SF preceding the preceding SF. This method can also stabilize the writing discharge, and provide a panel driving method capable of inhibiting increases in black picture level and displaying images at high quality.

Yet another aspect of the present invention provides a panel driving method, wherein the determining to cause one of the all-cell initializing operation and the selective initializing operation in the initializing period of each of the plurality of SFs can be performed according to a signal of an image to be displayed. This method can display an image having high contrast because the area displaying black picture has a low brightness at a low average picture level (APL) even though the image has an area having high brightness.

Still another aspect of the present invention provides a plasma display device using the above panel driving method. This structure can stabilize the writing discharge and provide a plasma display device capable of displaying images at high quality.

The present invention can provide a panel driving method and a plasma display device in which stabilizing the writing discharge inhibits increases in black picture level and allows images to be displayed at high quality.

### BRIEF DESCRIPTION OF THE DRAWINGS

FIG. 1 is a perspective view illustrating an essential part of a panel for use in a first exemplary embodiment of the present invention.

FIG. 2 is a diagram illustrating an array of electrodes of the panel for use in the first exemplary embodiment.

FIG. 3 is a circuit block diagram showing a structure of a plasma display device in accordance with the first exemplary embodiment.

FIG. 4 is a diagram showing driving waveforms to be applied to the respective electrodes of the panel for use in the first exemplary embodiment.

FIG. 5A is a diagram illustrating a structure of subfields in accordance with the first exemplary embodiment.

FIG. 5B is a diagram illustrating a structure of subfields in accordance with the first exemplary embodiment.

FIG. 5C is a diagram illustrating a structure of subfields in accordance with the first exemplary embodiment.

FIG. 6 is a table showing writing periods in a panel driving method in accordance with the first exemplary embodiment.

FIG. 7 is a table showing coding in accordance with a second exemplary embodiment of the present invention.

FIG. 8A is a diagram illustrating a structure of subfields in accordance with the second exemplary embodiment.

FIG. 8B is a diagram illustrating a structure of subfields in accordance with the second exemplary embodiment.

FIG. 8C is a diagram illustrating a structure of subfields in accordance with the second exemplary embodiment.

FIG. 9 is a table showing writing periods in a panel driving method in accordance with the second exemplary embodiment.

### REFERENCE MARKS IN THE DRAWINGS

1 Panel
2 Front substrate
3 Rear substrate
4 Scan electrode
5 Sustain electrode
9 Data electrode
12 Data electrodes driver circuit
13 Scan electrodes driver circuit
14 Sustain electrodes driver circuit
15 Timing-generating circuit
18 Analog/digital (AD) converter
19 Line number converter
20 Subfield converter
30 APL detector

### DETAILED DESCRIPTION OF PREFERRED EMBODIMENTS

Hereinafter, a description is provided of a panel driving method in accordance with exemplary embodiments, with reference to the accompanying drawings.

### First Exempraly Embodiment

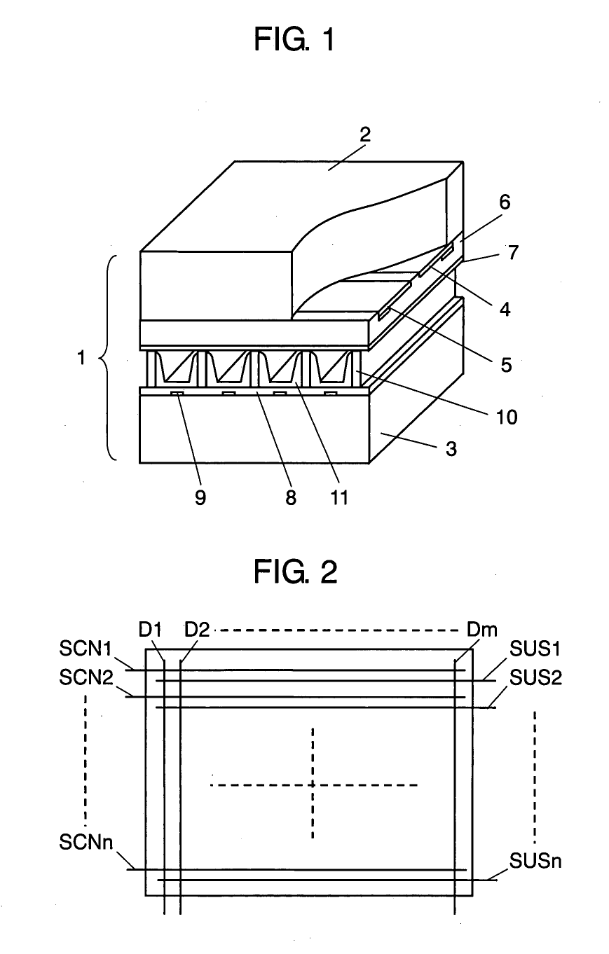

FIG. 1 is a perspective view illustrating an essential part of a panel for use in the first exemplary embodiment of the present invention. Panel 1 is composed of front substrate 2 and rear substrate 3 that are made of glass and faced with each other so as to form a discharge space therebetween. On front substrate 2, a plurality of display electrodes, each formed of a pair of scan electrode 4 and sustain electrode 5, are formed in parallel with each other. Dielectric layer 6 is formed to cover scan electrodes 4 and sustain electrodes 5. Over dielectric layer 6, protective layer 7 is formed. On rear substrate 3, a plurality of data electrodes 9 covered with insulating layer 8 are provided. Barrier ribs 10 are provided on insulating layer 8 between data electrodes 9 in parallel therewith. Also, phosphor layers 11 are provided on the surface of insulating layer 8 and the side faces of barrier ribs 10. Front substrate 2 and rear substrate 3 are faced with each other in a direction in which scan electrodes 4 and sustain electrodes 5 intersect data electrodes 9. In a discharge space formed between the substrates, a mixed gas, e.g. neon-xenon, is filled as a discharge gas.

FIG. 2 is a diagram showing an array of electrodes of the panel for use in the first exemplary embodiment of the present invention. N scan electrodes SCN 1 to SCNn (scan electrodes 4 in FIG. 1) and n sustain electrodes SUS 1 to SUSn (sustain electrodes 5 in FIG. 1) are alternately disposed in a row direction. M data electrodes D1 to Dm (data electrodes 9 in FIG. 1) are disposed in a column direction. A discharge cell is formed in a portion in which a pair of scan electrode SCNi and sustain electrode SUSi (i=1 to n) intersect one data electrode Dj (j=1 to m). Thus, m×n discharge cells are formed in the discharge space.

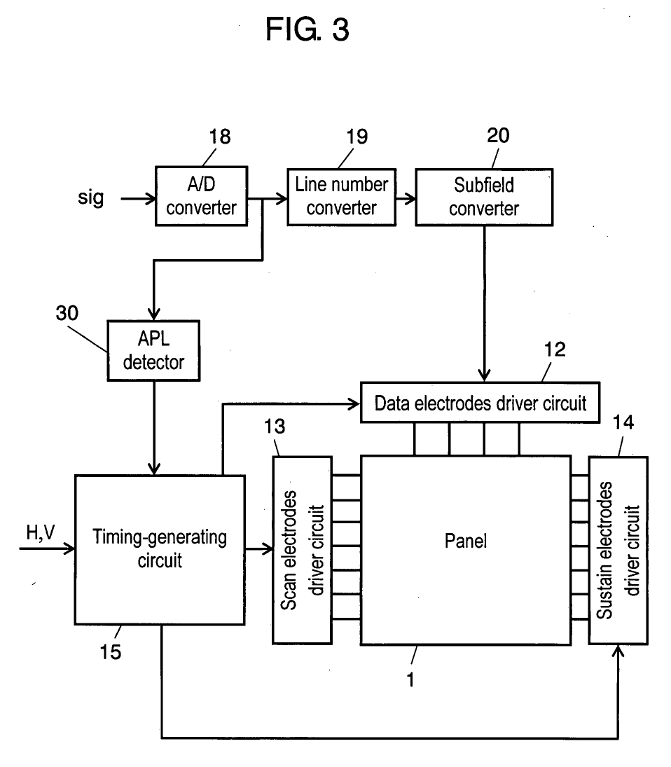

FIG. 3 is a circuit block diagram of a plasma display device in accordance with the first exemplary embodiment. The plasma display device includes panel 1, data electrodes driver circuit 12, scan electrodes driver circuit 13, sustain electrodes driver circuit 14, timing-generating circuit 15, analog-to-digital (A/D) converter 18, line number converter 19, subfield converter 20, average picture level (APL) detector 30, and power supply circuits (not shown).

With reference to FIG. 3, image signal sig is fed into A/D converter 18. Horizontal synchronizing signal H and vertical synchronizing signal V are fed into timing-generating circuit 15. A/D converter 18 converts image signal sig into image data of digital signals, and feeds the image data into line number converter 19 and APL detector 30. APL detector 30 detects the average picture level of the image data. Line number converter 19 converts the image data into image data corresponding to the number of pixels of panel 1, and feeds the image data to subfield converter 20. Subfield converter 20 divides the image data of the respective pixels into a plurality of bits corresponding to a plurality of subfields. The image data per subfield is fed into data electrodes driver circuit 12. Data electrodes driver circuit 12 converts the image data per subfield into signals corresponding to respective data electrodes D1 to Dm, and drives the respective data electrodes.

Timing-generating circuit 15 generates various kinds of timing signals based on horizontal synchronizing signal H and vertical synchronizing signal V, and feeds the timing signals to each circuit block. Responsive to the timing signals, scan electrodes driver circuit 13 feeds driving waveforms to scan electrodes SCN1 to SCNn. Responsive to the timing signals, sustain electrodes driver circuit 14 feeds driving waveforms to sustain electrodes SUS1 to SUSn. At this time, timing-generating circuit 15 controls the driving waveforms, according to an APL supplied from APL detector 30. Specifically, as described later, according to the APL, timing-generating circuit 15 determines to cause one of all-cell initializing operation and selective initializing operation in each of the subfields comprising one field, and controls the number of the all-cell initializing operations in one field and the period allocated to writing discharge per cell (hereinafter abbreviated as “writing period”).

Next, a method of driving the panel is described. In the first exemplary embodiment, one field is divided into 10 subfields (SF1 to SF10), and each of the subfields has a brightness weight of 1, 2, 3, 6, 11, 18, 30, 44, 60, or 80.

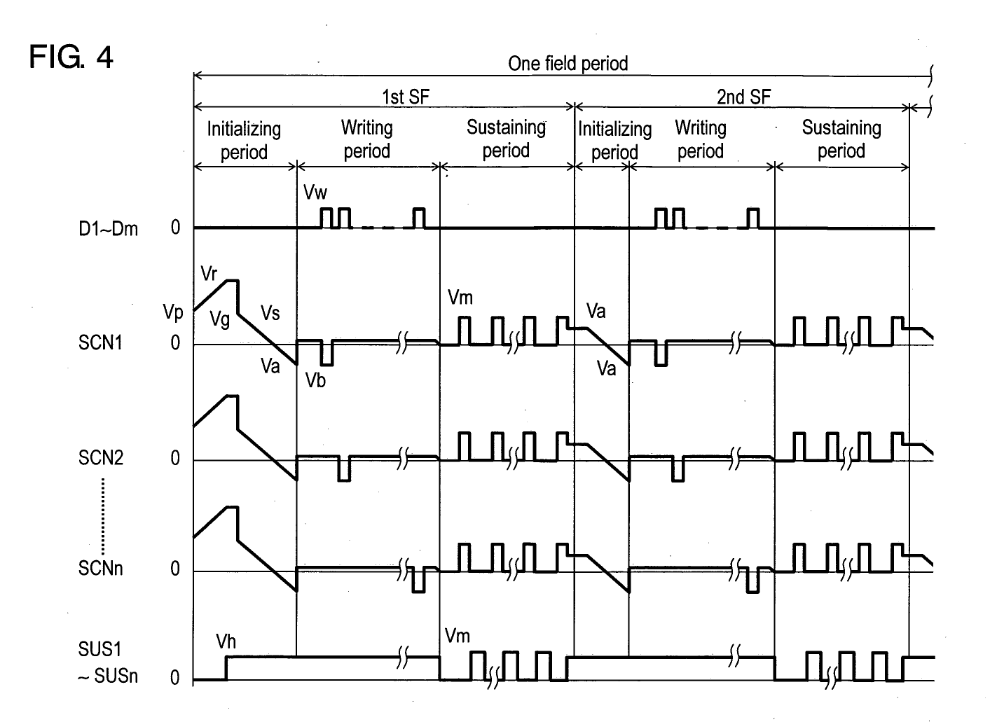

FIG. 4 is a diagram showing driving waveforms to be applied to the respective electrodes of the panel for use in the first exemplary embodiment of the present invention. In this embodiment, the initializing operation in the 1st SF is all-cell initializing operation, and the initializing operation in the 2nd SF is selective initializing operation.

In the initializing period in the 1st SF, while data electrodes D1 to Dm and sustaining electrodes SUS1 to SUSn are kept to 0 (V), a ramp voltage gradually increasing from voltage Vp (V) up to a discharge-starting voltage to voltage Vr (V) exceeding the discharge-starting voltage is applied to scan electrodes SCN1 to SCNn. This application causes first weak initializing discharge in all the discharge cells, accumulates negative wall voltage on scan electrodes SCN1 to SCNn and positive wall voltage on sustain electrodes SUS1 to SUSn and data electrodes D1 to Dm. Now, the wall voltage on the electrodes indicates the voltage generated by wall electric charge accumulating on the dielectric layer or phosphor layers covering the electrodes.

Thereafter, sustain electrodes SUS1 to SUSn are kept at positive voltage Vh (V), and a ramp voltage gradually decreasing from voltage Vg (V) to voltage Va (V) is applied to scan electrodes SCN1 to SCNn. This application causes second weak initializing discharge in all the discharge cells, weakens the wall voltage on scan electrodes SCN1 to SCNn and sustain electrodes SUS1 to SUSn, and adjusts the wall voltage on data electrodes D1 to Dm to a value appropriate for writing operation.

In this manner, in the all-cell initializing operation, initializing discharge is caused in all the discharge cells to generate priming.

In the subsequent writing period, scan electrodes SCN1 to SCNn are held at voltage Vs (V) once. Next, positive write pulse voltage Vw (V) is applied to data electrode Dk (k=1 to m) of a discharge cell to be lit in the first row among data electrodes D1 to Dm, and negative scan pulse voltage Vb (V) is applied to scan electrode SCN1 in the first row. Then, a voltage amounting to the sum of the write pulse voltage and scan pulse voltage, i.e. Vw+Vb (V), is applied across scan electrode SCN1 and data electrode Dk, thus exceeding the discharge-starting voltage. This application causes discharge at the intersection of scan electrode SCN1 and data electrode Dk, and develops discharge between scan electrode SCN1 and sustain electrode SUS1 in the corresponding cell. Thus, wall charge necessary for subsequent sustaining discharge accumulates. In this manner, writing discharge is completed in the discharge cell in the first row to which write pulse voltage Vw (V) is applied. On the other hand, in the discharge cells to which write pulse voltage Vw (V) is not applied, no writing discharge occurs and thus no wall charge accumulates. At this time, positive write pulse voltage Vw (V) is applied to data electrode Dk in the discharge cells in the second row or after. However, in the second row or after, no negative scan pulse voltage Vb (V) is applied to the corresponding scan electrode, and thus the voltage applied across the scan electrode and data electrode Dk is write pulse voltage Vw (V) only. For this reason, the voltage of the cells in the second row or after does not exceed the discharge-starting voltage and causes no writing discharge.

Next, positive write pulse voltage Vw (V) is applied to data electrode Dk of a discharge cell to be lit in the second row, and negative scan pulse voltage Vb (V) is applied to scan electrode SCN2 in the second row. Then, a voltage amounting to the sum of the write pulse voltage and scan pulse voltage, i.e. Vw+Vb (V), is applied across scan electrode SCN2 and data electrode Dk, thus exceeding the discharge-starting voltage. This application causes writing discharge in the discharge cell in the second row to which write pulse voltage Vw (V) is applied. On the other hand, in the discharge cells to which write pulse voltage Vw (V) is not applied, no writing discharge occurs and thus no wall charge accumulates. Also at this time, the voltage applied across the scan electrodes and data electrode Dk in the discharge cells in the 3rd row or after is write pulse voltage Vw (V) only. For this reason, the voltage of the cells in the 3rd row or after does not exceed the discharge-starting voltage and causes no writing discharge.

Such writing operation is sequentially performed on the discharge cells in the 3rd row to n-th row, and the writing period is completed.

In the subsequent sustaining period, first, sustain electrodes SUS1 to SUSn are reset to 0V, and positive sustain pulse voltage Vm (V) is applied to scan electrodes SCN1 to SCNn. At this time, in the discharge cells in which writing discharge has occurred, a voltage generated by wall charge is added to sustain pulse voltage Vm (V), and thus exceeds the discharge-starting voltage and causes sustaining discharge. Then, wall charge having the reverse polarity accumulates in the discharge cells. Next, resetting scan electrodes SCN1 to SCNn to 0 (V) and applying positive sustain pulse voltage Vm (V) to sustain electrodes SUSI to SUSn causes sustaining discharge in the discharge cells and reverses the polarity of the wall charge. Alternately applying the sustain pulses to scan electrodes SCN1 to SCNn and sustain electrodes SUS1 to SUSn in the similar manner continues sustaining discharge in the discharge cells in which writing discharge has occurred in the writing period.

In the initializing period in the 2nd SF, while sustain electrodes SUS1 to SUSn are kept at Vh (V) and data electrodes D1 to Dm at 0(V), a ramp voltage decreasing to voltage Va (V) is applied to scan electrodes SCN1 to SCNn. Then, in the discharge cells in which sustaining discharge has occurred in the sustaining period in the preceding subfield, weak initializing discharge occurs and forms wall charge necessary for the subsequent writing operation. On the other hand, in the discharge cells in which no writing discharge or sustaining discharge has occurred in the preceding subfield, no discharge occurs, and the wall charge at the completion of the initializing period in the preceding subfield is kept.

In this manner, for the selective initializing operation, initializing discharge occurs in the discharge cells in which sustaining discharge has occurred in the preceding subfields, and thus no priming is generated in the discharge cells in which no sustaining discharge has occurred.

The operation performed in the writing period in the 2nd SF is the same as that of the writing period in the 1st SF. Even though the brightness weight in the sustaining period in the 2nd SF is different from that in the 1st SF, otherwise the brightness weight is the same as that in the writing period in the 1st SF. Also in the SFs after the 3rd SF, as described above, the all-cell initializing operation or selective initializing operation is performed in the initializing period, the writing operation is performed in the writing period, and the sustaining operation is performed in the sustaining period. Thus, the descriptions thereof are omitted.

Next, a description is provided of a structure of subfields in the driving method of the first exemplary embodiment. As described above, in this embodiment, one field is divided into 10 subfields. However, in the present invention, the number of subfields or the brightness weight of each subfield is not limited to the above values.

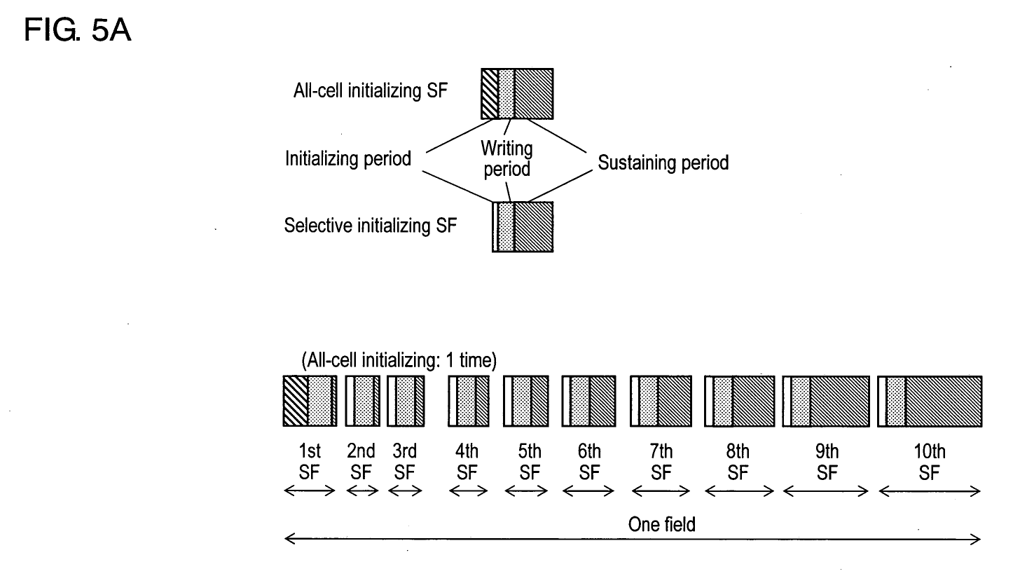

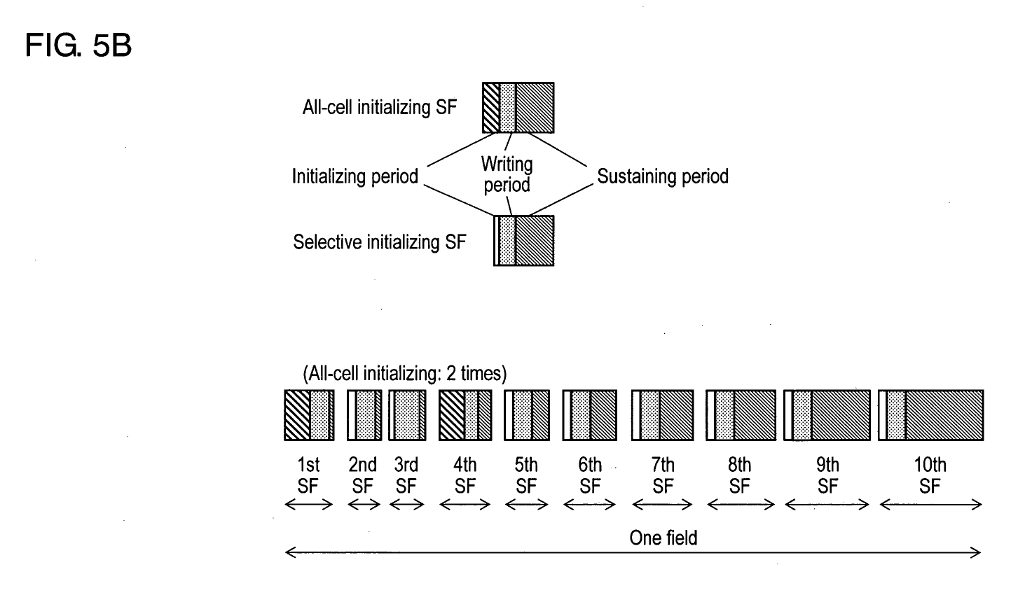

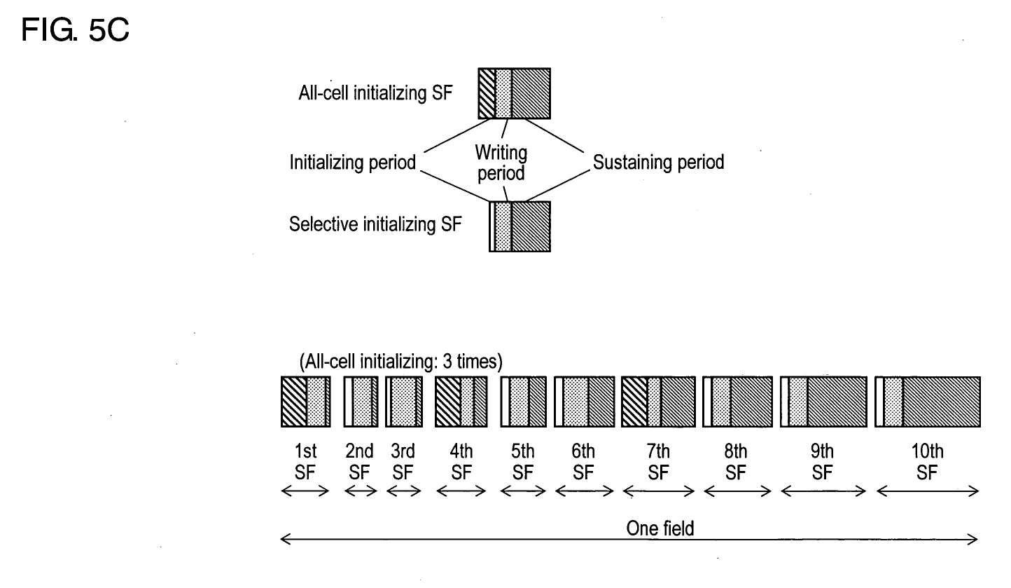

FIGS. 5A through 5C are diagrams, each illustrating a structure of subfields (SF) of the first exemplary embodiment of the present invention. The subfield structure is changed according to the APL of the signals of an image to be displayed. FIG. 5A shows a structure to be used when the image signal has an APL ranging from 0 to 1.5% (inclusive). In this structure, the all-cell initializing operation occurs in the initializing period in the 1st SF only; the selective initializing operation occurs in the initializing periods in the 2nd to 10th SFs. FIG. 5B shows a structure to be used when the image signal has an APL ranging from 1.5 to 5% (inclusive). In this SF structure, the all-cell initializing operation occurs in the initializing periods in the 1st and 4th SFs; the selective initializing operation occurs in the initializing periods in the 2nd, 3rd, and 5th to 10th SFs. FIG. 5C shows a structure to be used when the image signal has an APL ranging from 5 to 100% (inclusive). In this SF structure, the initializing periods in the 1st, 4th, and 7th SFs are all-cell initializing periods; those in the 2nd, 3rd, 5th, 6th, 8th to 10th SFs are selective initializing periods.

As described above, in the first exemplary embodiment, because it is considered that there is no or a small area displaying a black picture when an image having a high APL is displayed, the number of all-cell initializing operations and thus priming are increased to stabilize discharge. In contrast, it is considered that there is a large area displaying a black picture when an image having a low APL is displayed. Thus, the number of all-cell initializing operations is reduced to improve black display quality. Therefore, an image having high contrast can be displayed because the area displaying a black picture has a low brightness weight at a low APL even though the image has areas having high brightness.

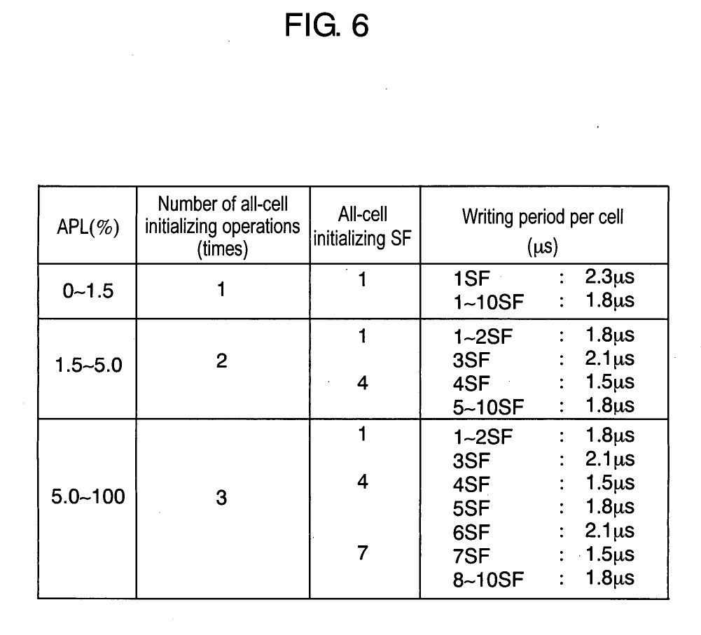

FIG. 6 is a table showing writing periods in the panel driving method in accordance with the first exemplary embodiment. When the all-cell initializing operation is performed in the initializing period in the 1st SF only in this manner, the respective writing periods per cell in the 1st to 10th SFs are set to 2.3 μs, 1.8 μs, 1.8 μs, 1.8 μs, 1.8 μs, 1.8 μs, 1.8 μs, 1.8 μs, 1.8 μs, and 1.8 μs. When the all-cell initializing operation is performed in the initializing periods in the 1st and 4th SFs, the respective writing periods per cell in the 1st to 10th SFs are set to 1.8 μs, 1.8 μs, 2.1 μs, 1.5 μs, 1.8 μs, 1.8 μs, 1.8 μs, 1.8 μs, 1.8 μs, and 1.8 μs. When the all-cell initializing operation is performed in the initializing periods in the 1st, 4th, and 7th SFs, the respective writing period per cell in the 1st to the 10th SFs are set to 1.8 μs, 1.8 μs, 2.1 μs, 1.5 μs, 1.8 μs, 2.1 μs, 1.5 μs, 1.8 μs, 1.8 μs, and 1.8 μs. Now, when the writing periods for the all-cell initializing operation occurring in the 1st and 4th SFs are focused, the writing period in the 4th SF in which the all-cell initializing operation occurs is set shorter than each of the writing periods in the 2nd, 3rd, and 5th to 10th SFs in which the selective initializing occurs. The writing period in the 3rd SF preceding the 4th SF in which the all-cell initializing operation occurs is set much longer than the writing period in the preceding 2nd SF. When the writing periods for the all-cell initializing operation occurring in the 1st, 4th, and 7th SFs are focused, each of the writing periods in the 4th and 7th SFs in which the all-cell initializing operation occurs is set shorter than each of the writing periods in which the selective initializing occurs. The each of writing periods in the 3rd and 6th SFs preceding the 4th and 7th SFs in which the all-cell initializing operation occurs is set much longer than each of writing periods in the preceding 2nd and 5th SFs, respectively.

Hereinafter, a description is provided of the reason why the writing periods of a SF in which the all-cell initializing operation occurs and its preceding SF are set in this manner. As described above, the all-cell initializing operation works not only to form wall charge necessary for the writing operation but also to generate priming for smaller discharge delay and more stable writing discharge. Thus, because sufficient priming supplied immediately after the all-cell initializing period reduces discharge delay in writing discharge, even a short writing period can generate stable writing discharge. In contrast, because insufficient priming increases discharge delay in a SF distant from the all-cell initializing period, setting a somewhat longer writing period in the SF is effective to generate stable writing discharge.

However, a too long writing period tends to destabilize writing discharge. Why the. too long writing period destabilizes the writing discharge is not elucidated. However, it is considered as follows.

When ensuring writing control in a writing period is intended, application of either of write pulse voltage Vw (V) or scan pulse voltage Vb (V) across scan electrode SCNi and data electrode Dk generates no writing discharge. It is necessary to generate writing discharge by applying both write pulse voltage Vw (V) and scan pulse voltage Vb (V). In the all-cell initializing period, wall charge Vwall (V) appropriate for writing operation accumulates on data electrodes D1 to Dm. For this reason, both of the sum of write pulse voltage Vw (V) and wall voltage Vwall (V) and the sum of scan pulse voltage Vb (V) and wall voltage Vwall (V) are set lower than the discharge-starting voltage so that application of either one of write pulse voltage Vw (V) or scan pulse voltage Vb (V) generates no writing discharge. Then, the sum of write pulse voltage Vw (V), scan pulse voltage Vb (V), and wall voltage Vwall (V) is set higher than the discharge-starting voltage to generate writing discharge only when both of write pulse voltage Vw (V) and scan pulse voltage Vb (V) are applied.

However, in a discharge cell in which write pulse voltage is applied to data electrode Dk and no scan voltage is applied to scan electrode SCNi, the sum of write pulse voltage Vw (V) and wall voltage Vwall (V) is applied across scan electrode SCNi and data electrode Dk. Even though the sum of write pulse voltage Vw (V) and wall voltage Vwall (V) is set lower than the discharge-starting voltage, a flow of small dark current can decrease wall voltage Vwall (V) at a voltage near the discharge-starting voltage. If the dark current flows for a long period and decreases wall charge Vwall (V) to a non-negligible degree, decreases in the voltage applied across scan electrode SCNi and data electrode Dk, i.e. Vw+Vb +Vwall (V), are consider to hinder generation of writing discharge, or destabilize writing discharge.

Particularly during displaying an image having high brightness, the dark current flows for a longer period, and the dark current is increased by increases in priming. Thus, it is highly possible that wall voltage Vwall (V) decreases to a non-negligible degree and destabilizes writing discharge. In the discharge cells in which sustaining discharge does not occur, this decrease in wall voltage Vwall (V) persists until the next all-cell initializing operation.

To prevent the above decrease in wall voltage Vwall (V), shortening the period during which the dark current flows is effective. For this purpose, the writing period cannot be extended unnecessarily. Particularly in the case of successive subfields in which the selective initializing operation is performed, this point should be noted because decreased wall voltage Vwall (V) cannot be compensated during the initializing period. In other words, in a SF preceding a SF in which the all-cell initializing operation occurs, the writing period can be set longer to increase priming because the decrease in wall voltage Vwall (V) can be compensated during the subsequent all-cell initializing period.

For the above reason, setting the writing periods in the SFs in which the all-cell initializing operation occurs shorter is preferable in the terms of not only allowing sufficient time for driving but also preventing the decrease in wall voltage Vwall (V) caused by excessive priming particularly during displaying an image with a high APL. In the SF preceding a SF in which the all-cell initializing operation occurs, the writing period can be set longer to some degree because the decrease in wall voltage Vwall (V) can be compensated by the all-cell initializing operation.

In the first exemplary embodiment, the writing period in the 1st SF in a SF structure having an APL ranging from 0 to 1.5% is set to an exceptionally large value of 2.3 μs. This is to perform stable writing operation even in the discharge cells having large discharge delay caused by insufficient priming because no sustaining discharge is considered to occur in the SFs having large brightness weights in most of the discharge cells in display of an image having a low APL. Additionally, because little priming decreases the dark current, a somewhat longer writing period cannot destabilize writing discharge.

### Second Exemplary Embodiment

The structures of a panel and a plasma display panel device for use in the second exemplary embodiment are the same as those of the first exemplary embodiment. Difference of the second embodiment from the first embodiment is the subfield (SF) structure and the gradation display method thereof. For the second exemplary embodiment, one field is divided into 12 subfields (SF1 to SF12), and each of the subfields has a brightness weight of 1, 2, 3, 6, 11, 18, 28, 32, 34, 37, 40 or 44.

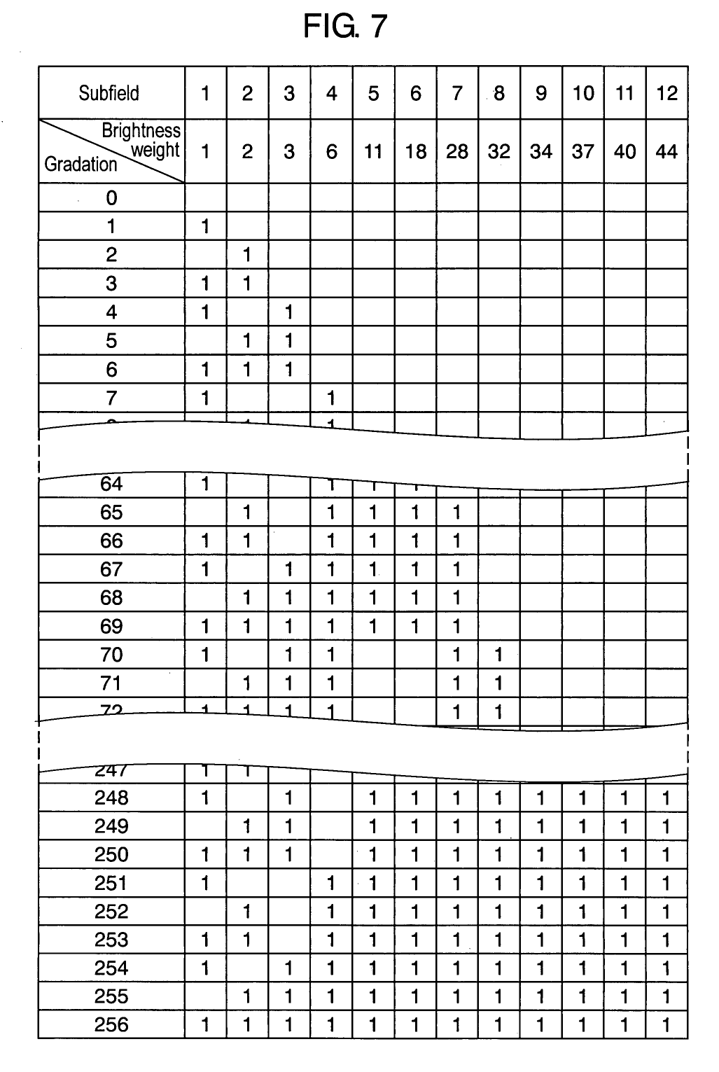

FIG. 7 is a table showing display gradations and combinations of SFs to be lit to display the gradations, i.e. so-called coding, in accordance with the second exemplary embodiment. Now, “1” indicates that the SF is to be lit, and a blank column indicates that the SF is not to be lit. The coding of the second exemplary embodiment is characterized in that SFs to be lit and those not to be lit are randomly determined in the 1st to 6th SFs, according to the gradations to be displayed. Hereinafter, such a method of displaying gradations is referred to as random coding. In the 7th to 12th SFs, SFs to be lit and those not to be lit are determined so that there are successive SFs to be lit with the 7th SF at the top thereof. Hereinafter, such a method of displaying gradations is referred to as successive coding. Displaying gradations using the successive coding has an advantage of causing no so-called dynamic false contours. On the other hand, this displaying method also has a disadvantage of considerably limiting the number of gradations that can be displayed. In the second embodiment, to offset such a disadvantage of the successive coding, twelve SFs comprising one field are divided into two SF groups. For gradation display, the SF group having larger brightness weights (7th to 12th SFs) uses the successive coding, and the SF group having smaller brightness weights (1st to 6th SFs) uses the random coding to increase display gradations.

In this case, the writing periods in the SF group using the successive coding (successive-coding SFs) except the top one, i.e. the 8th to 12th SFs, can be set shorter. The reason is described as follows. When any one of the 8th to 12th SFs is lit, the SF preceding the any SF is always a SF to be lit. Thus, in the sustaining period in the preceding SF, sustaining discharge gives a sufficient priming effect and reduces the discharge delay in the writing discharge in the subsequent SF.

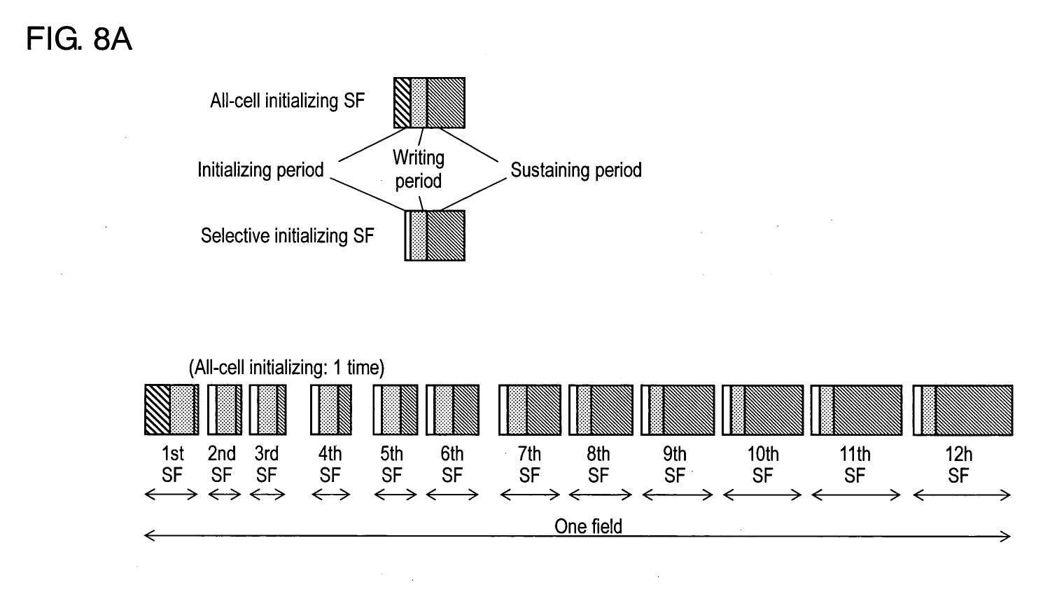

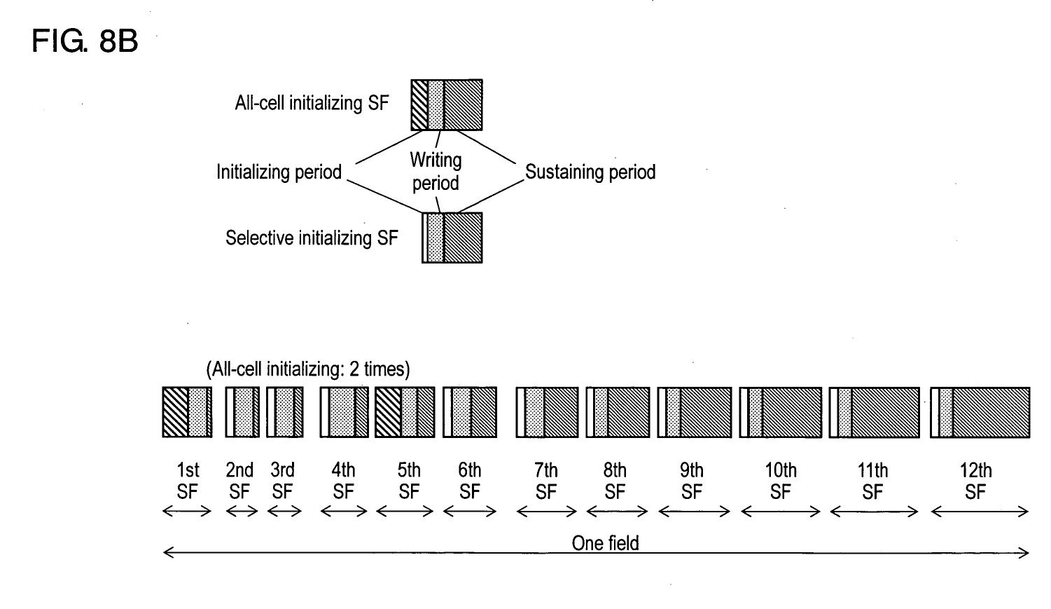

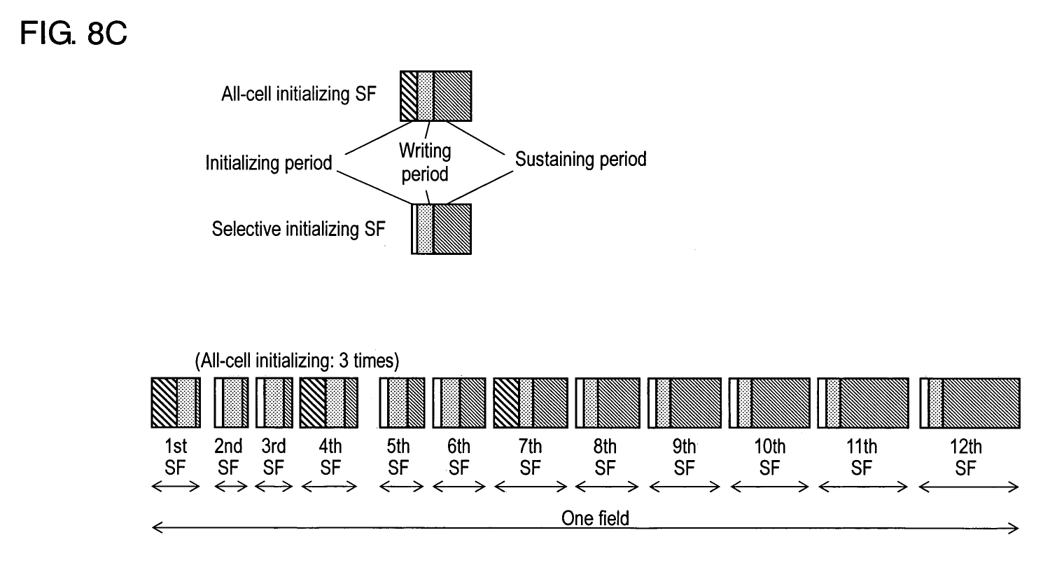

FIGS. 8A through 8C are diagrams, each illustrating a structure of subfields (SF) of the second exemplary embodiment of the present invention. The SF structure is changed according to the APL of the signals of an image to be displayed. FIG. 8A shows a structure to be used when the image signal has an APL ranging from 0 to 1.5% (inclusive). In this structure, the all-cell initializing operation occurs in the initializing period in the 1st SF only; the selective initializing operation occurs in the initializing periods in the 2nd to 12th SFs. FIG. 8B shows a structure to be used when the image signal has an APL ranging from 1.5 to 5% (inclusive). In this SF structure, the all-cell initializing operation occurs in the initializing periods in the 1st and 5th SFs; the selective initializing operation occurs in the initializing periods in the 2nd to 4th, and 6th to 12th SFs. FIG. 8C shows a structure to be used when the image signal has an APL ranging from 5 to 100% (inclusive). In this SF structure, the initializing periods in the 1st, 4th, and 7th SFs are all-cell initializing periods; those in the 2nd, 3rd, 5th, 6th, 8th to 12th SFs are selective initializing periods.

In this manner, also in the second exemplary embodiment, increasing the number of all-cell initializing operations increases priming to stabilize discharge in display of an image having a high APL. In contrast, decreasing the number of all-cell initializing operations improves black display quality in display of an image having a low APL. For this reason, an image having high contrast can be displayed because the area displaying a black picture has a low brightness at a low APL even though the image has areas having high brightness.

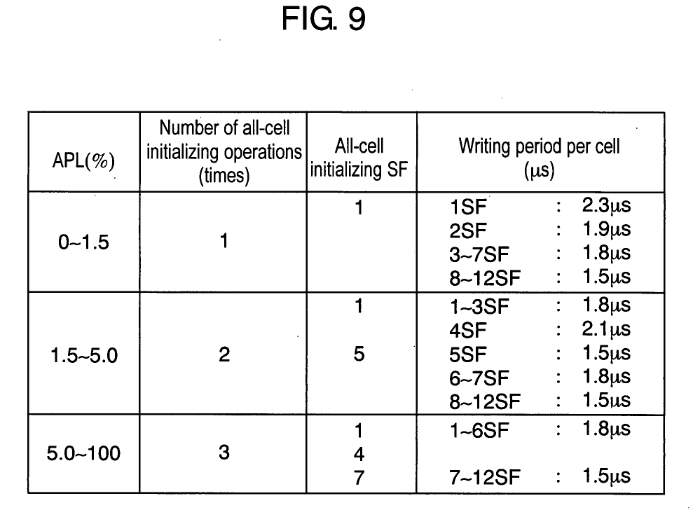

FIG. 9 is a table showing writing periods in the panel driving method in accordance with the second exemplary embodiment. When the all-cell initializing operation occurs in the initializing period in the 1st SF only in this manner, the respective writing periods per cell in the 1st to the 12th SFs are set to 2.3 μs, 1.9 μs, 1.8 μs, 1.8 μs, 1.8 μs, 1.8 μs, 1.8 μs, 1.5 μs, 1.5 μs, 1.5 μs, 1.5 μs, and 1.5 μs. When the all-cell initializing operation occurs in the initializing periods in the 1st and 5th SFs, the respective writing periods per cell in the 1st to 12th SFs are set to 1.8 μs, 1.8 μs, 1.8 μs, 2.1 μs, 1.5 μs, 1.8 μs, 1.8 μs, 1.5 μs, 1.5 μs, 1.5 μs, 1.5 μs, and 1.5 μs. When the all-cell initializing operation occurs in the initializing periods in the 1st, 4th, and 7th SFs, the respective writing periods per cell in the 1st to 12th SFs are set to 1.8 μs, 1.8 μs, 1.8 μs, 1.8 μs, 1.8 μs, 1.8 μs, 1.5 μs, 1.5 μs, 1.5 μs, 1.5 μs, 1.5 μs, and 1.5 μs.

Because the all-cell initializing operation generates priming as described above, even a short writing period immediately after the all-cell initializing period can generate stable writing discharge. When the writing periods for the all-cell initializing operation occurring in the 1st and 5th SFs are focused, the writing period in the 5th SF in which the all-cell initializing operation occurs is set shorter than each of the writing periods in the SF group having the smaller brightness weights in which the selective initializing occurs. In the SF preceding the SF including the all-cell initializing period, the writing period is set to somewhat longer. In this embodiment, the writing period in the 4th SF is set longer than that of the 3rd SF, which precedes the 4th SF. However, because the 8th to 12th SFs use the successive coding, the writing periods thereof are set shorter.

The above example describes the writing periods in the 5th and 4th SFs in the present invention when the all-cell initializing operation occurs in the initializing periods in the 1st and 5th SFs. However, the present invention can be implemented when the all-cell initializing operation occurs in the initializing periods in the 1st, 4th, and 7th SFs. For example, the respective writing periods per cell in the 1st to 12th SFs can be set to 1.8 μs, 1.8 μs, 2.1 μs, 1.5 μs, 1.8 μs, 2.1 μs, 1.5 μs, 1.5 μs, 1.5 μs, 1.5 μs, 1.5 μs, and 1.5 μs. In this example, the writing periods in the 4th and 7th SFs in which the all-cell initializing operation occurs are set shorter than the writing periods in the SFs in which the selective initializing operation occurs. The writing periods in the 3rd and 6th SFs preceding the 4th and 7th SFs in which the all-cell initializing operation occurs are set longer than the SFs preceding the 3rd and 6th SFs, respectively.

For the same reason as the first exemplary embodiment, the writing period in the first SF in the SF structure having an APL ranging from 0 to 1.5% is set to an exceptionally longer value of 2.3 μs.

In the descriptions of the second exemplary embodiment, one field is made of 12 SFs and the number of all-cell initializing operations are controlled within the range from 1 to 3 times. However, the present invention is not limited to these values.

### INDUSTRIAL APPLICABILITY

A panel driving method of this invention can inhibit increases in black picture level and display images at excellent quality. Thus, the present invention is useful for an image display device or the like, using a panel.

1. A plasma display panel driving method, in which one field period comprises a plurality of subfields (SFs), each of the SFs including an initializing period for generating initialing discharge in discharge cells, a writing period for generating writing discharge in the discharge cells, and a sustaining period for generating sustaining discharge to cause the discharge cells to emit light at a predetermined brightness weight; the initializing discharge includes all-cell initializing operation for causing initializing operation in all the discharge cells to be used to display an image, and selective initializing operation for selectively causing initializing operation in the discharge cells having generated sustaining discharge in a preceding one of the SFs thereof, and a period allocated to the writing discharge in one of the SFs for performing the all-cell initializing operation is set shorter than a period allocated to the writing discharge in another one of the SFs for performing the selective initializing operation; and each of the discharge cells is formed at an intersection of scan and sustain electrodes and a data electrode, the method comprising:
determining to cause one of the all-cell initializing operation and the selective initializing operation in the initializing period in each of the plurality of SFs.

2. The plasma display panel driving method of claim 1, comprising:
setting a period allocated to the writing discharge in one of the SFs preceding another one of the SF for performing the all-cell initializing operation longer than a period allocated to the writing discharge in still another one of the SFs preceding the one of the SFs.

3. The plasma display panel driving method of claim 1, wherein the determining to cause one of the all-cell initializing operation and the selective initializing operation in the initializing period in each of the plurality of SFs is performed according to a signal of an image to be displayed.

4. The plasma display panel driving method of claim 2, wherein the determining to cause one of the all-cell initializing operation and the selective initializing operation in the initializing period in each of the plurality of SFs is performed according to a signal of an image to be displayed.

5. A plasma display device using the plasma display panel driving method of claim 1.

6. A plasma display device using the plasma display panel driving method of claim 2.

7. A plasma display device using the plasma display panel driving method of claim 3.

8. A plasma display device using the plasma display panel driving method of claim 4.
